(19) United States
(12) Patent Application Publication
(10) Pub. No.: US 2007/0283150 A1
(43) Pub. Date: Dec. 6, 2007

(54) System and method for secure messaging and web service communication

(75) Inventor: Costin Cozianu, Torrance, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/444,620

(22) Filed: Jun. 1, 2006

(51) Int. Cl. H04L 9/00

(52) U.S. Cl. 713/168

(57) ABSTRACT

Sensitive or confidential information is received in to a serialization library where it is associated with one or more fields. Fields into which such information is received are tagged with a type identifier representative of the sensitive or confidential nature of associated field content. Information thus tagged is then automatically encrypted with either a process associated key or a session associated key. Encrypted messages are then communicated to an associated web service or message service. Such encryption is particularly useful in automatically encrypting confidential information in XML-based systems.

### BACKGROUND OF THE INVENTION

The subject application is directed to network data communication, and more particularly to a system and method by which confidential or sensitive information may be communicated securely. The invention is particularly applicable to web-based data communication, such as that employing Extensible Mark-up Language (XML), and will be described with particular reference thereto. However, it is to be appreciated that the subject system and method is suited to any secure network data communication, as well as systems and methods in which encryption is employed for inter-process data communication on a single computer or workstation.

The Internet, and particularly the World Wide Web, is increasingly being used for transmission of financial information, commercial information, personal information and business information. Frequently, such information is resultant from input on a Web page, such as by filing out an on-line form. Information may also come from messages, such as those that are entered into a web page. Information may also come from one of the many applications that use proprietary or customized interfaces to communicate information to financial institutions, such as the CheckFree service, Quicken service, and a host of tax preparation software that allows for communication with financial institutions or electronic filing of returns. There are many such applications available, and the list grows daily as electronic communication, such as Internet-based communication, continues to be integrated into daily life.

As will be noted from the forgoing, much of the information that is being transmitted is confidential or sensitive in nature. Any communication of such information via a common network runs a risk of interception or misrouting. This risk is particularly significant when information is communicated between a widely shared, open network, such as the global Internet.

Given the many applications and platforms that need to communicate information, there is a recognized need for interoperability and compatibility. The Organization for the Advancement of Structured Information Standards (“OASIS”) is a consortium founded in 1993 that continues to work to address these concerns. The work of OASIS includes digital signatures and encryption to protect sensitive or confidential information. Additionally, the Web Services Interoperability Organization (“WSI”) was created to promote Web services interoperability across platforms, applications and programming languages.

Both OASIS and WSI have recognized a need for secure communication of information between applications or services, such as Web services. While progress in this goal continues to be made, two major platforms, Java, of Sun Microsystems, Inc. and “.NET”, of Microsoft Corporation, do not implement desired interoperability. This failure is particularly evident in connection with implementation of these platforms in connection with encryption and digital signatures in XML. XML documents include not only electronic documents, such as word processing files, but include many other data formats, such as vector graphics, e-commerce transactions, mathematical equations, object meta-data, and server application program interfaces (“APIs”), as well as many other formats that employ structured information.

In XML, a Document Type Definition functions to define legal building blocks of an XML documents. It defines a document structure with a list of legal elements. An XML schema describes a structure of an XML document. The XML schema language is referred to as the XML Schema Definition.

One concern with approaches toward digital encryption and signatures, such as that currently employed by the WSI, is that it commences with a premise that data is described in a prescribed XML data model, such as Document Type Definition, XML Schema Definition, and the like. However, in common practice, developers look at data as “object types” as a platform of choice. An object type is a descriptor that conveys information about a given sub-area or object of a document with regard to the manner in which it conveys data or information. More simply, object types are used in object-oriented programming and function to wrap a non-object type and make it look like an object. Object types are favored insofar as they have richer semantics.

Currently no system teaches a mechanism by which object types are effectively used to provide for protection of sensitive or confidential information, particularly in interoperability situations such as in XML or .NET based systems. The subject application overcomes the above-noted problems and provides a system and method by which confidential or sensitive information may be communicated securely

### SUMMARY OF THE INVENTION

In accordance with the subject application, there is provided a system and method by which confidential or sensitive information may be communicated securely.

Further, in accordance with the subject application, there is provided a system and method for secure data communication that is particularly suited to any secure network data communication, as well as systems and methods in which encryption is employed for inter-process data communication on a single computer or workstation.

Still further, in accordance with the present invention, there is provided a system for secure data communication that receives message data from an associated process in to a serialization library. The serialization library includes functions to detect language level attributes associated with fields of the message data. Data associated with one or more selected fields is encrypted by use of key data, which key data corresponds to at least one of a process and session associated with the message data. Encrypted message data is then communicated to an associated service.

Still further, in accordance with the present invention, there is provided a method for secure data communication. The method receives into a serialization library, from an associated process, message data directed to an associated system. The method also detects language level attributes associated with fields of the message data and receives key data, which key data corresponds to at least one of a process and session associated with the message data. Data associated with one or more selected fields is encrypted by use of key data in accordance with language level attributes. Encrypted message data is then communicated to an associated service.

In accordance with a more limited aspect of the subject application, message data includes a capsule type identifier associated with each of a plurality of the fields. Language level attributes are detected in accordance therewith.

In accordance with another aspect of the subject application, the associated process is comprised of at least one of a web-based service and a messaging system.

In accordance with another aspect of the subject application, at least one capsule type identifier value is associated with sensitive or confidential data.

In accordance with a more limited aspect of the subject application, the encrypted message includes at least one of message sent, web service call and logging information.

An advantage of the disclosed system is the secure transmission of information that is associated with object types.

Another advantage of the disclosed system is the provision of secure transmission of information that is effective for Web based data communication, including XML and .NET communication.

Yet another advantage of the disclosed system is the provision of secure transmission of information wherein encryption and transmission is automatic upon entry of sensitive or confidential information.

Still other advantages, aspects and features of the present invention will become readily apparent to those skilled in the art from the following description wherein there is shown and described a preferred embodiment of this invention, simply by way of illustration of one of the best modes best suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The subject invention is described with reference to certain figures, wherein:

FIG. 1 is a network diagram illustrating an application of a secure data communication as taught in the subject application;

FIG. 2 is a diagram of a suitable system on which web services as taught by the subject application is accomplished;

FIG. 3 is a diagram of a suitable system on which secure data communication as taught by the subject application is accomplished;

FIG. 4 is a diagram of interaction of a process with a network communication embodying secure data communication as taught by the subject application; and

FIG. 5 is a flow diagram of a preferred embodiment of the subject application showing formation of secure communication as taught by the subject application.

### DETAILED DESCRIPTION OF THE PREFERRED EMBODIMENT

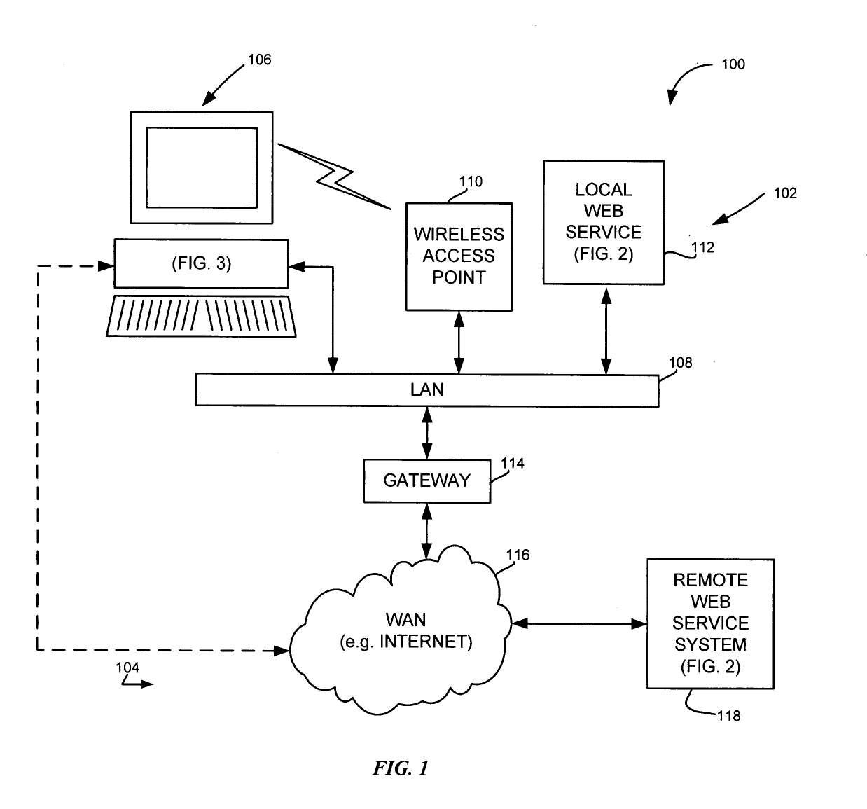

Turning now to the drawings, the showings are for illustration of the preferred embodiment, only, and not for the purpose of limiting the same, FIG. 1, illustrates a distributed communication system 100 which includes a local portion 102 and a remote portion 104. The system is illustrated as having two processes which are end points to the secure communication disclosed herein. It will be appreciated from the description below that these two processes have suitably any number of intermediary computing nodes or transmission media therebetween. Such intermediary points include routers, servers, messaging software, wireless networks, wired networks and both local and wide area networks, such as the global Internet. It is further to be appreciated that the subject teaching is not limited to point-to-point communications, and is applicable to communications such as published/subscribe, event/notification mechanisms, as well as any suitable one to many and many to many communication system as may be suitably employed in a distributed system.

In the illustration of FIG. 1, a local portion 102 includes a computer system 106, suitably comprised of a workstation in data communication with at least one additional computing node or process. In the preferred embodiment, this communication is performed through a network. The illustration of FIG. 1 shows a local area network 108 into which a workstation 106 is interconnected for data interchange. It is to be appreciated that communication to the network is suitably direct, such as with a network interface card and an Ethernet connection. It is also to be appreciated that such communication is suitably done wirelessly, such as with a wireless access point 110.

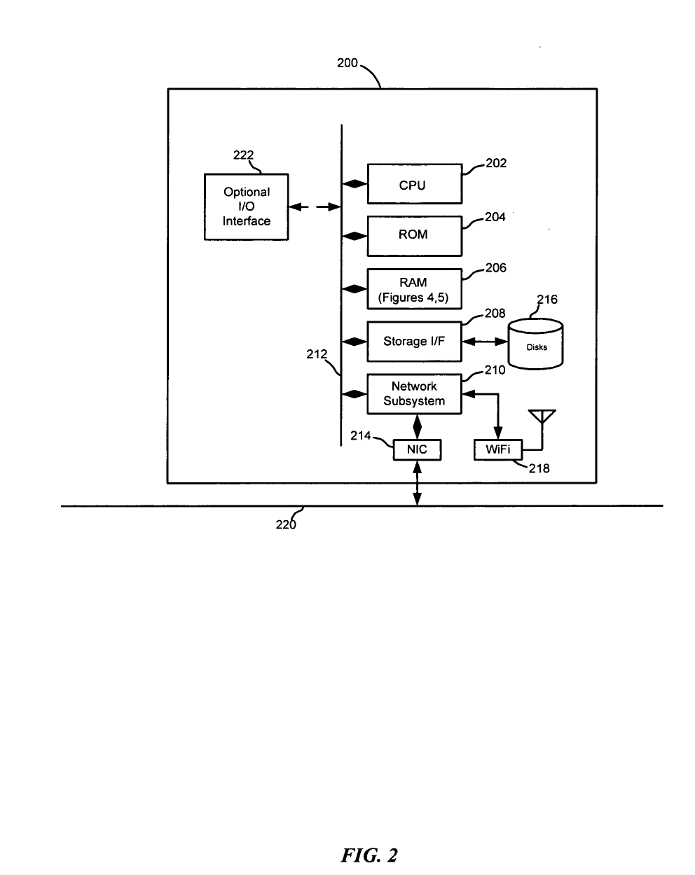

The distributed communication system 100 as taught herein is advantageously applied between a process running on computer, such as workstation 106, in communication with a process on a web service. A local web service 112 is also placed in data communication with the local area network 108. Alternatively, local area network 108 communicates via a gateway 114 to a wide area network, such as the global Internet, through which communication to a remote web service system 118 is accomplished. The remote web service system 118 in this instance provides a second process for data communication as will be detailed below. It will be understood by those skilled in the art that the local web service 112 and the remote web service system 118 are suitably provided via the use of a server, such as that depicted in FIG. 2, discussed in greater detail below. Preferably, the server providing such services is any hardware, software or suitable combination thereof capable of providing the services envisioned in accordance with the subject application. It will be appreciated that workstation 106 also suitably communicates directly with a wide area network 116, such as in a direct Internet connection.

Turning now to FIG. 2, illustrated is a representative architecture of a suitable server 200 on which operations of the subject system are completed. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration, and other routines or data used for operation of the server 200.

Also included in the server 200 is random access memory 206, suitably formed of dynamic random access memory, static random access memory, or any other suitable, addressable memory system. Random access memory provides a storage area for data instructions associated with applications and data handling accomplished by processor 202.

A storage interface 208 suitably provides a mechanism for volatile, bulk or long term storage of data associated with the server 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the server 200 to communicate to other devices. Network interface subsystem 210 suitably interfaces with one or more connections with external devices to the server 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and network subsystem 210 is suitably accomplished via a bus data transfer mechanism, such as illustrated by bus 212.

Suitable executable instructions on the server 200 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 222 as will be appreciated by one of ordinary skill in the art.

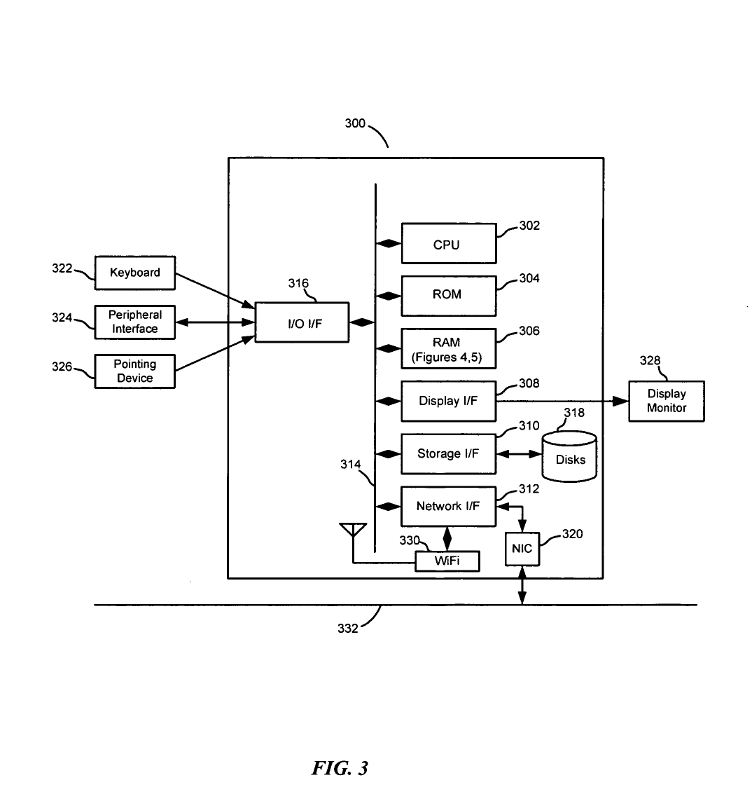

Referring now to FIG. 3, illustrated is a hardware diagram of a suitable workstation 300 for use in connection with the subject system. A suitable workstation includes a processor unit 302 which is advantageously placed in data communication with read only memory 304, suitably non-volatile read only memory, volatile read only memory or a combination thereof, random access memory 306, display interface 308, storage interface 310, and network interface 312. In a preferred embodiment, interface to the foregoing modules is suitably accomplished via a bus 314.

Read only memory 304 suitably includes firmware, such as static data or fixed instructions, such as BIOS, system functions, configuration data, and other routines used for operation of the workstation 300 via CPU 302.

Random access memory 306 provides a storage area for data and instructions associated with applications and data handling accomplished by processor 302.

Display interface 308 receives data or instructions from other components on bus 314, which data is specific to generating a display to facilitate a user interface. Display interface 308 suitably provides output to a display terminal 326, suitably a video display device such as a monitor, LCD, plasma, or any other suitable visual output device as will be appreciated by one of ordinary skill in the art.

Storage interface 310 suitably provides a mechanism for non-volatile, bulk or long term storage of data or instructions in the workstation 300. Storage interface 310 suitably uses a storage mechanism, such as storage 318, suitably comprised of a disk, tape, CD, DVD, or other relatively higher capacity addressable or serial storage medium.

Network interface 312 suitably communicates to at least one other network interface, shown as network interface 320, such as a network interface card. It will be appreciated that by one or ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by on of ordinary skill in the art.

An input/output interface 316 in data communication with bus 314 is suitably connected with an input device 322, such as a keyboard or the like. Input/output interface 316 also suitably provides data output to a peripheral interface 324, such as a USB, universal serial bus output, SCSI, Firewire (IEEE 1394) output, or any other interface as may be appropriate for a selected application. Finally, input/output interface 316 is suitably in data communication with a pointing device interface 328 for connection with devices, such as a mouse, light pen, touch screen, or the like.

The subject system is advantageously provided in data exchanged in language constructs of a host environment communication process. By way of example, if processes are implemented in Java or C language, each message type will include a corresponding class. The subject system employs a serialization library which functions to convert data between internal representation of Java or C, as well as other host language objects, and a messaging/web service. In a preferred embodiment, such communication is accomplished in the XML format.

In operation, the workstation 106 executes code, which calls a messaging application programming interface that enables communications between processes. A serialization algorithm is then called by the messaging application programming interface for use on associated message information. That is, data is either placed or received in a field of a message corresponding to the confidential nature of the data. In accordance therewith, the subject application enables the placement or receipt of data into a message field that indicates that confidentiality is not needed or not necessary. When no confidential information is contained in the message to the next process, the message is transmitted to the next process and the operation terminates. Preferably, the message is transmitted in XML form to the next process, e.g., web services, network framework, logging, or other services.

When it is determined that confidential information is contained within the message between processes, each field in the message is recursively tested in a message tree for confidential information. The current field containing the confidential information is then detected, such as the detection of language level attributes, and a determination is made whether the field denotes an encryption requirement. When such a determination is positive, the data associated with the message is encrypted in accordance with the current field. A determination is then made whether an associated field is marked to be signed. When such a determination is positive, any field marked for signing is signed. Thereafter, an XML primitive is applied to the content of the signed field, as well as to those non-marked fields. The XML primitive is also applied to a current operation and appended to an XML node. A determination is then made whether recursive transversal is finished for all the fields in the associated message. When this determination is negative, the operations return to recursively finish any remaining fields in the message. When positive, the XML node is then transmitted to the next process, e.g., the underlying web service, network framework, or other process.

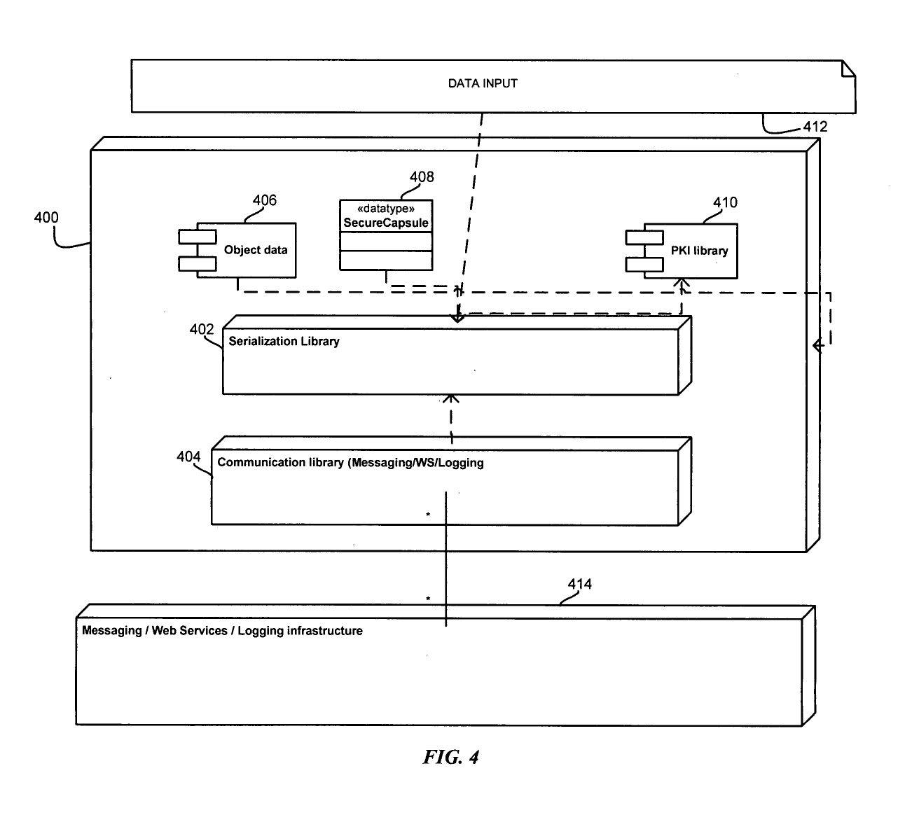

Turning to FIG. 4, a process 400 is suitably realized on a workstation 106 (FIGS. 1 and 3). The process 400 includes a serialization library 402 and a communication library 404. Object data 406 is received in processor 400. Secure capsule data 408 and public key infrastructure (“PKI”) library 410 are also associated with process 400.

The serialization library 402 functions to detect which part of data that is directed to the interchange between processes is sensitive or confidential. As used herein, “confidential” will be understood to mean any data for which security, sensitivity, or other need to prevent unauthorized dissemination is included. Such confidential information is desired to be encrypted or signed such that cryptographic operations are provided on a content or value of associated fields. In this fashion, no data will leave a secure host environment without having undergone a desired transformation to an encrypted form.

The serialization library 402 advantageously makes use of process specific keys which are suitably obtained from PKI library 410. In addition, certain cases advantageously make use of session specific keys from PKI library 410, such that, even within a same system, no hijacked intermediary components can gain access to data. This is true even if all processes use a same host language and a same format. Thus, the session specific keys facilitate that even the information sent to system logs is transformed by the serialization library such that sensitive information cannot be leaked.

In the system of FIG. 4, data is received from a data input 412 into the serialization library 402. Data input 412 is suitably a user-interface such as a thin client or web input, or via any suitable messaging application program interface, as will be understood by those skilled in the art. Received data is associated with object data 406. Selected object data types are ascertained by a specific data type set at 408. These data types are provided with key base encryption from PKI library 410, such that specific object types will have automatically applied encryption to data associated therewith. Thus, the serialization library 402 suitably receives input from exterior processes, such as messaging, web services or logging messages or other processors, and detects language level attributes associated with fields of received message data. In a preferred embodiment, a capsule type identifier is associated with one or more folders. Thus a value of each particular capsule type identifier is advantageously used to identify associated image level attributes. Next, the serialization library 402 receives key data, corresponding to a process and/or session such that it is associated with the message data, and selectively encrypts respective fields of received message data using the key data. Encrypted message data is suitably communicated to an associated messaging/web service/logging infrastructure 414, which is suitably another digital device or a process. By way of example, the process 400 suitably runs in the workstation 106 (FIG. 1) while the process 414 suitably runs in the local web service 112 or the remote web service system 118. In this fashion, an encrypted message suitably includes at least one of a message sent, web service call, and logging information. Serialization library 402 suitably releases at least one of a message received value and a web service return value.

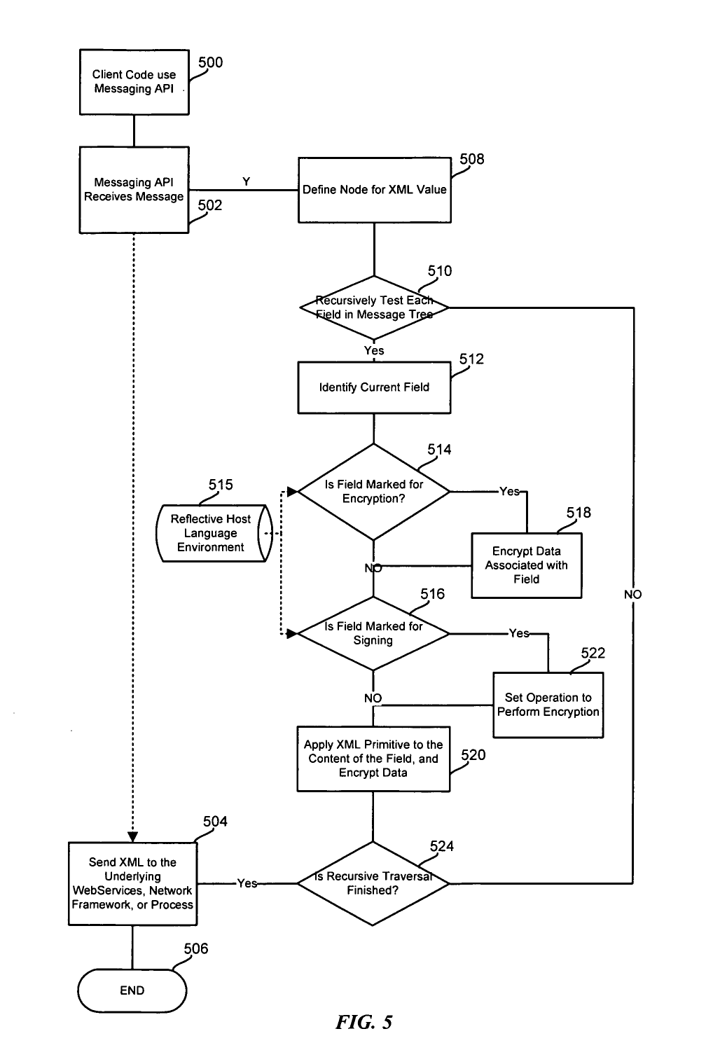

Thus, the illustration of FIG. 4 shows a basic block diagram of the various components associated with the interprocess communication. Next, a detailed description of the process itself by which data is received and encapsulated for transmission between processes will be detailed in connection with FIG. 5. In FIG. 5, at step 500, code on a client, such as workstation 106, calls a messaging application programming interface (“API”) to allow for communication between processes at step 500. Next, at step 502, the messaging API calls a serialization algorithm for associated message information. In step 502, data is either placed or received in a field that corresponds to a confidential nature of the asserted data, or a field which indicates that such confidentiality is unnecessary or unneeded. In the event that the field indicates that the associated information is not confidential, progress is made immediately to step 504 and a communication is then sent to the second process, such as the process employing messaging, web services or logging as noted earlier. Once such message is completed, the system suitably terminates at step 506.

In the event that confidential information is found at step 502, progress is made to step 508. In a preferred embodiment, XML language is used for communication of data. By way of example, at step 508 an XML node is suitably set as empty to commence the process. Next, at step 510, each field is recursively tested in a message tree for the confidential message. At step 512, a property of this field is detected, such as detection of language level attributes associated with a field. A check of such a field identifier is completed at step 512.

At step 514, a determination is made as to whether information in a specified field is present so as to include confidential information such as to require encryption. A positive determination causes progress to step 518, at which point encryption of associated data is made. Operations in the current operation are made in concert with a corresponding host environment as noted by 515. In the event a field does not designate encryption, or the event encryption has been made, progress moves to step 516.

At this point, a determination is made whether an associated field is marked for signing. Positive determination causes progress to block 522 which, analogously to the steps of step 518, causes data associated with that field to be marked for signing. In that instance, both any field not marked for signing, or any that have been marked for signing, progress to step 520. Step 520 is particularly suited to the XML environment. At this point, an XML primitive is applied to a content of the field, then applied to a current operation and appended to a XML node. A determination is then made at step 524 to determine whether recursive transversal is finished for all fields in the message. A positive determination causes progress to block 504 for transmission. A negative determination causes a return to block 510 to finish recursively any remaining fields.

From the foregoing, it will be appreciated that cryptographic protection attributes are suitably specified on a system wide basis and at a class definition level. A serialization transform is applied automatically upon transmitting of information outside of a process or receiving information inside a process. Thus, security attributes are enforced consistently and verification can be made that the system has desired security properties, and is leak free.

By purposes of illustration of a preferred embodiment using XML language, a representative pseudo code is included as Table 1.

TABLE 1
PSEUDOCODE FOR XML IMPLEMENTATION

```
Any serialization will be a function performed on an object, called the root object, that will return
the XML representation of all information accessible through that root object, by inspecting atomic
type fields directly and by inspecting the fields whose content are of type Object (non-atomic
fields) recursively (following their fields, and the fields of their object fields, etc). The root object is
thus distinguished from all the other objects visited by the transformation algorithm recursively by
the fact that it is the entry point in the algorithm, and upon the deserialization the reference to the
reconstructed root object will be the result returned by the deserialization function.
Serialization : Object -> XML
Deserialization : XML -> Object
A root object is defined by its actual class that it belongs to and the values of its fields, let the
class be noted as:
rootObject.getClass( ) == RootObjectClass
Let there also be an auxiliary function called TransformClassName
    ClassName : Class -> String
That will be defined later, for the beginning we can assume it to be java.lang.Class.getName( ) or
the equivalent Type class in C#/.NET.
There's also a introspection function that determines for each user defined class whether it has
been declared to require special security property (signing and/or encryption), so it returns a list
of security properties
    DeclaredSecurity: Class -> [SecurityProperty]
Then the XML output of the serialization function is defined as:
Serialize(rootObject) ==
    < ClassName(RootObjectClass) >
        RepresentContent(rootObject)
    </ ClassName(RootObjectClass) >
Where RepresentContent( ) is a function defined from Object to an array of XML Elements, that
we discuss further.
RepresentContent: Object -> XMLElement[ ] | String // Xml Element or String
In the general case RepresentContent will return an array of XML elements with two exceptions
for String objects and byte array objects it will return a special encoding of their content. Let us
denote the fields of an object as follows:
object.getFields( ) == objectFields[ ] =={ field1, field2, ... fieldN }
where N is the number of the fields and also the length of objectFields array.
If the object is anything but an array, its fields are its instance variables. A field will thus have the
following properties
```

| | |
|---|---|
| 1. fieldname : String | (known at compile-time |
| 2. declaredType : Class | (known at runtime) |
| 3. actualContent: (Object \| [primitive type] ) | (known at run-time) |

```
If the object is an array, as far as both Java and C# languages are concerned, it doesn't have
instance variables, but for the purpose of this specification we'll consider the components of the
array as fields. Therefore if the array is of length N it will have N anonymous fields (the fieldname
property is empty), but whose declared type is known to be the declared type of the array, as well
as the actual content known at run-time.
The function getFields( ) will be defined thus for the purpose of this specification to return the
array of all object fields, with the exception of those instance variables marked with the
transient attribute. In case of an array none of its components are marked transient.
Next, define the function RepresentContent as
    RepresentContent(object) ==
    CryptoLibrary.getTransformationFor(
        DeclaredSecurity( object.getClass( ) )
        )
        .applyTo (
        If
            (object.getClass( )== byte[ ].class ) Then RepresentByteArray(object)
        Else If
            (object.getClass( ) == String.class ) Then RepresentString(object)
        Else
        new XMLElement[ ] {
            SerializeField(object.getFields( )[0]),
            SerializeField(object.getFields( )[1]),
            ...
            SerializeField(object.getFields( )[N−1]) }
      )
Or more formally, for fields other than byte arrays.
    RepresentContent == map (getFields , SerializeField)
where ‘map‘ is a list/array transformation function that produces a new list/array having the
elements defined by the application of the input function (second parameter) to the corresponding
elements of the input array in the natural order.
The function SerializeField -> XMLElement used in the definition of RepresentContent is further
defined as
    SerializeField (field) ==
    If (field.fieldName == null ) Then // the array case
        If (field.actualContent != null ) Then
            If (field.declaredtype.isPrimitive( ))
                < field.declaredtype >
                RepresentPrimitive(field.actualContent)
                </field.declaredtype>
            else
                Serialize(field.ActualContent)
        Else
            <null />
    Else If (field.DeclaredType.isPrimitive( )) Then
        <field.fieldname>
        RepresentPrimitive(field.actualContent)
        </field.fieldname>
    Else If (field.actualContent == null ) Then
        <field.fieldname > < null /> </ field.fieldname >
    Else
        < field.fieldname ClassAttribute(field) >
        RepresentContent(field.actualContent)
        </ field.fieldname >
    As will be appreciated by those skilled in the art, the following is an example of a
target XML. The signed XML content:
    <?xml version=“1.0” encoding=“utf-8”?>
      <S11:Envelope xmlns:S11=“...” xmlns:wsse=“...” xmlns:wsu=“...”
    xmlns:ds=“...”>
    <S11:Header>
      <wsse:Security xmlns:wsse=“...”>
      <xxx:CustomToken wsu:Id=“...” xmlns:xxx=“http://.../token”>
        FHUIORv...
      </xxx:CustomToken>
      <ds:Signature>
      <ds:SignedInfo>
      <ds:CanonicalizationMethod
    Algorithm=“http://www.w3.org/2001/10/xml-exc-c14n#”/>
      <ds:SignatureMethod Algorithm=
    “http://www.w3.org/2000/09/xmldsig#hmac-sha1”/>
      <ds:Reference URI=“#MsgBody”>
      <ds:DigestMethod Algorithm=
    “http://www.w3.org/2000/09/xmldsig#sha1”/>
      <ds:DigestValue>LyLsF0Pi4wPU...</ds:DigestValue>
      </ds:Reference>
      </ds:SignedInfo>
      <ds:SignatureValue>DJbchm5gK...</ds:SignatureValue>
      <ds:KeyInfo>
      <wsse:SecurityTokenReference>
      <wsse:Reference URI=“...”/>
      </wsse:SecurityTokenReference>
      </ds:KeyInfo>
      </ds:Signature>
      </wsse:Security>
      </S11:Header>
      <S11:Body wsu:Id=“MsgBody”>
        <tru:StockSymbol xmlns:tru=“http://fabrikam123.com/payloads”>
        QQQ
        </tru:StockSymbol>
      </S11:Body> 337
      </S11:Envelope> 338
```

The skilled artisan will appreciate that the forgoing represents a name of a stock symbol, for example, being returned by a webservice, wherein the signature certifies the authenticity of the information. Preferably, the signature is generated by the following declaration in the host programming language, including, for example and without limitation Java and C#:

```
public class MsgBody {
        [Signed(SHA1)]
    String StockSymbol
}
```

Those of ordinary skill in the art will understand that the foregoing declaration informs the serialization framework to sign the stock symbol variable on the outward leg of transmission. It will become readily apparent to those skilled in the art that rather than beginning with a complicated XML-declaration via WS-Security, the user is capable of employing a shorter and simpler host language declaration, thereby driving the XML content being exchanged between processes participating in the webservice.

The invention extends to computer programs in the form of source code, object code, code intermediate sources and partially compiled object code, or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A system for secure data communication comprising:
receiving means adapted for receiving into a serialization library, from an associated process, message data directed to an associated system;
the serialization library including,
detection means adapted for detecting language level attributes associated with fields of the message data,
means adapted for receiving key data, which key data corresponds to at least one of a process and session associated with the message data, and
means adapted for selectively encrypting, using received key data, fields of received message data in accordance with an output of the detection means; and
output means adapted for communicating encrypted message data to an associated process.

2. The system for secure data communication of claim 1 wherein the message data includes a capsule type identifier associated with each of a plurality of the fields, and wherein the detection means detects language level attributes in accordance therewith.

3. The system for secure data communication of claim 2 wherein the associated system is comprised of at least one of a web-based service and a messaging system.

4. The system for secure data communication of claim 3 further comprising means adapted for associating at least one capsule type identifier value with confidential data.

5. The system for secure data communication of claim 4 further including a user interface comprising:
means adapted for prompting an associated user for input data;
means adapted for receiving input data from an associated user, which input data includes confidential data; and
means adapted for communicating received confidential data into fields associated with the at least one capsule type identifier.

6. The system for secure data communication of claim 4 wherein the encrypted message from the output means includes at least one of message sent, web service call, and logging information.

7. The system for secure data communication of claim 4 wherein the receiving means includes at least one of a message received value and a web service return value.

8. A method for secure data communication comprising the steps of:
receiving into a serialization library, from an associated process, message data directed to an associated system;
detecting language level attributes associated with fields of the message data,
receiving key data, which key data corresponds to at least one of a process and session associated with the message data,
selectively encrypting, using received key data, fields of received message data in accordance with language level attributes; and
communicating encrypted message data to an associated service.

9. The method for secure data communication of claim 8 wherein the message data includes a capsule type identifier associated with each of a plurality of the fields, and wherein the step of detecting detects language level attributes in accordance therewith.

10. The method for secure data communication of claim 9 wherein the associated system is comprised of at least one of a web-based service and a messaging system.

11. The method for secure data communication of claim 10 further comprising the step of associating at least one capsule type identifier value with confidential data.

12. The method for secure data communication of claim 11 further comprising the steps of:
prompting an associated user for input data;
receiving input data from an associated user, which input data includes confidential data; and
communicating received confidential data into fields associated with the at least one capsule type identifier.

13. The method for secure data communication of claim 11 wherein the encrypted message includes at least one of message sent, web service call, and logging information.

14. The method for secure data communication of claim 11 wherein the step of receiving includes at least one of a message received value and a web service return value.

15. A computer-implemented method for secure data communication comprising the steps of:
receiving into a serialization library, from an associated process, message data directed to an associated system;
detecting language level attributes associated with fields of the message data,
receiving key data, which key data corresponds to at least one of a process and session associated with the message data,
selectively encrypting, using received key data, fields of received message data in accordance with language level attributes; and
communicating encrypted message data to an associated service.

16. The computer-implemented method for secure data communication of claim 15 wherein the message data includes a capsule type identifier associated with each of a plurality of the fields, and wherein the step of detecting detects language level attributes in accordance therewith.

17. The computer-implemented method for secure data communication of claim 16 wherein the associated system is comprised of at least one of a web-based service and a messaging system.

18. The computer-implemented method for secure data communication of claim 17 further comprising the step of associating at least one capsule type identifier value with confidential data.

19. The computer-implemented method for secure data communication of claim 18 further comprising the steps of:
prompting an associated user for input data;
receiving input data from an associated user, which input data includes confidential data; and
communicating received confidential data into fields associated with the at least one capsule type identifier.

20. The computer-implemented method for secure data communication of claim 18 wherein the encrypted message includes at least one of message sent, web service call, and logging information and wherein the step of receiving includes at least one of a message received value and a web service return value.
